(19) United States
(12) Patent Application Publication
(10) Pub. No.: US 2021/0293081 A1
(43) Pub. Date: Sep. 23, 2021

(54) HURRICANE DOOR

(71) Applicant: V Tech Industries, L.P., Houston, TX (US)

(72) Inventors: Arthur J. VALENTZ, Sugar Land, TX (US); John E. Nemazi, Bloomfield Hills, MI (US)

(73) Assignee: V Tech Industries, L.P., Houston, TX (US)

(21) Appl. No.: 16/824,422

(22) Filed: Mar. 19, 2020

(51) Int. Cl. E06B 5/12; E06B 3/54; E06B 1/52; B32B 17/10; B32B 27/36; B32B 27/40

(52) U.S. Cl. CPC E06B 5/12; E06B 3/5454; E06B 1/52; B32B 17/10064; E06B 2003/7049; B32B 17/10752; B32B 17/1077; B32B 27/365; B32B 27/40; B32B 17/10091

(57) ABSTRACT

An entryway door is capable of withstanding direct hit hurricane loads and subsequent water surge for long periods. A door slab is formed of reaction-injected-molded aliphatic polyurethane having an outward face, and inward face, and a peripheral edge, with a window opening formed therethrough. A ballistic glass-clad polycarbonate laminate window is provided which sized larger than the window opening. The laminate window having a central light transmissive region and an outer boarder region. A primer border is applied to the outer boarder region of outward and inward faces of the laminate window. The door slab is reaction-injected-molded about the laminate window with the outer boarder region extending into and is bonded to a portion of the door slab forming the window opening. The preferred door in mounted to a structure in an outwardly opening manor with a seal entrapped between the periphery of the door and a door jam.

### TECHNICAL FIELD

The present disclosure relates to entryway doors and particularly to doors designed to withstand High Velocity Hurricane Zone forces.

### BACKGROUND

A number of companies sell doors designed to withstand High Velocity Hurricane Zone forces. These doors are typically designed to withstand up to a 140 MPH winds and survive a 50 MPH large missile impart test. There remains a need to provide a practical and economical entryway door capable of withstanding extremely high wind speeds of up to 250 MPH and withstand multiple 100 MPH large missile strikes for use in hurricane shelters.

### SUMMARY

The disclosed entryway door is capable of withstanding direct hit hurricane loads and subsequent water surge for long periods of time. The door has a door slab formed of reaction injected molded aliphatic polyurethane having an outward face, and inward face, and a peripheral edge, with a window opening formed therethrough. A ballistic glass-clad polycarbonate laminate window is provided which sized larger than the window opening. The laminate window having a central light transmissive region and an outer boarder region. A primer border is applied to the outer boarder region of outward and inward faces of the laminate window. The door slab is reaction injected molded about the laminate window with the outer boarder region extending into and is bonded to a portion of the door slab which extends about the window opening.

The preferred the outer boarder region extends into and is bonded to a portion of the door slab a distance of 1.0-2.5 inches opens outwardly. The door slab inward face forms a flat surface which when closed compress a seal against a doorjamb. The doorjamb and the seal extend about the entire periphery of the door.

In a preferred example of the entryway door the outer boarder region extends into and is bonded to a portion of the door slab a distance of 1.0-2.5 inches. The door slab is reaction injected molded about the laminate window with the outer boarder region extending into and bonded to a portion of the door slab extending about the window opening.

Additionally, in a preferred embodiment example, an outwardly opening entryway door assembly capable of withstanding hurricane loads and water surge is disclosed. The door assembly comprises a door jamb defining an opening for an outwardly singing door with a door jamb abutment which extends about an entire inner periphery of the door jamb opening. The assembly includes the previously described entryway door, a hinge set mounting the door to the doorjamb and a peripheral seal. This door assembly is capable of meeting Federal Emergency Management Agency (FEMA), FEMA ICC-500 Large Missile Impact test.

### BRIEF DESCRIPTION OF THE DRAWINGS

FIG. 1 is a perspective view of an example of an outwardly opening entryway door attached to an enclosure with the door in the open position;

FIG. 2 is a perspective view of the door of FIG. 1 in the closed position;

FIG. 3 is a sectional view taken along line 3-3 in FIG. 1;

FIG. 4 is an enlarged sectional view of the glass-clad polycarbonate laminate window showing the layer structure;

FIG. 5. is a section of the door jamb illustrating the doorjamb hinge side abutment and the seal; and

FIG. 6 is a section of the door jamb illustrating the door jamb lock side having an insert molded lock plate reinforcement.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

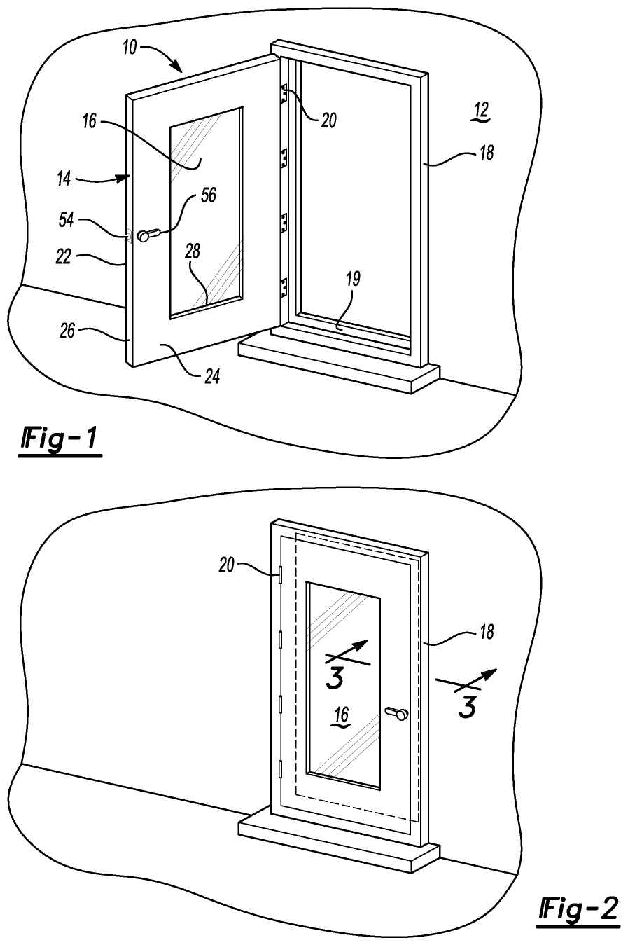

A perspective view of an example of an outwardly opening entryway door 10 attached to an enclosure 12 with the door in the open position is shown in FIG. 1 and a closed position in FIG. 2. The door 10 is made up of a door slab 14 and a ballistic glass-clad polycarbonate laminate window 16. The door 10 is mounted to a doorjamb 18 by a series of hinges 20. Preferably four commercial grade hinges are use. The door jamb 18 preferably has a jamb abutment 19 which extends about all four sides of the door unlike a typical door with a two or three sided jab abutment and a door sill.

The preferred embedment door slab 14 is formed of reaction-injected-molded aliphatic polyurethane. The door slab 14 has an outward face 22, and inward face 24, and a peripheral edge 26, with a window opening 28 formed therethrough. The reaction-injected-molding process used to encapsulate the window in polyurethane structure is described in detail in Applicant's earlier U.S. Pat. No. 7,762,028 entitled window-containing assemblies having a molded plastic frame, issued Jul. 27, 2010 which is incorporated in in entirety. The present application has adapted this technology to fabricated doors designed to withstand High Velocity Hurricane forces with winds exceeding 250 MPH.

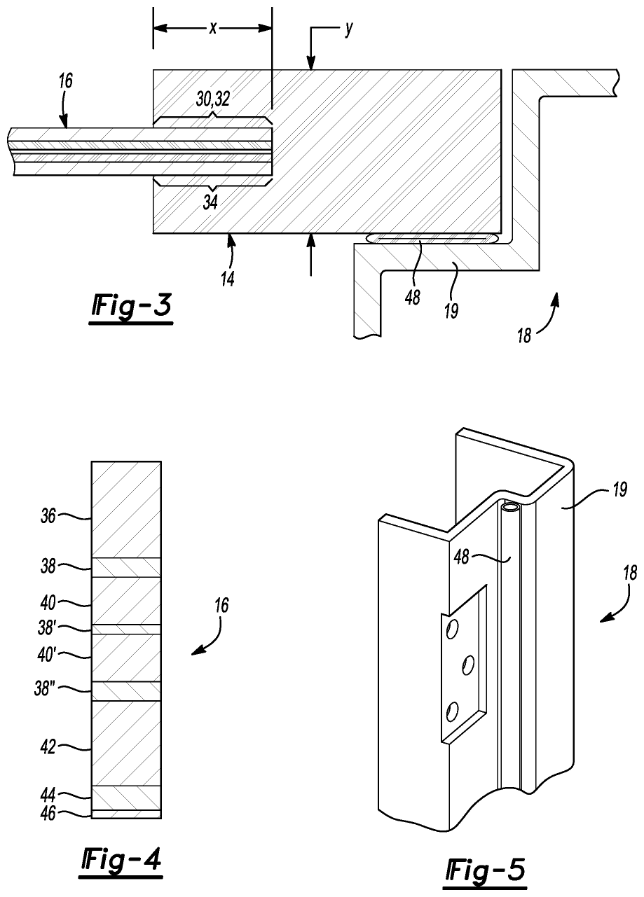

Ballistic glass-clad polycarbonate laminate window 16 is significantly larger than window opening 28 enabling the outer peripheral edge 30 to extend a distance X into the door slab 14 as illustrated in FIG. 3. Distance X is 1.0-2.5 inches and preferably about 2 inches. To form a secure bond with the reaction-injected-molded aliphatic polyurethane material forming the door slab 14 outer peripheral edge 30 a primer border is applied to the outer boarder regions 32 and 34 of the outward and inward faces of the laminate window.

The preferred laminated glass when installed in the door assembly 10 passes the UL Level 1 Ballistic and Forced Entry test and the FEMA ICC-500 Large Missile Impact test. The disclosed embodiment is on outwardly opening door design. This causes the inward load on the door to push the door tightly against the door jamb abutment 19 which extend about the entire periphery of the doorjamb 18 and door 10. As seal 48 is oriented between the doorjamb abutment 19 and the peripheral edge of the door slab 14 forming a watertight seal which can withstand a 6 foot tall of water leak test. The seal 48 can be affixed to the doorjamb abutment 49 as shown in FIG. 5 or alternatively affixed to the periphery of the inside of the door slab 14.

Suitable primers also include Betaseal 43518 Glass Primer and Betaseal 43520A Glass Primer commercially available from Dow Chemical Company BetasealT 43518 Glass Primer is a proprietary composition which includes toluene, methyl alcohol, and an organosilane Betaseal 43520A Glass Primer is a proprietary composition which includes toluene, methyl ethyl ketone, carbon black, n-butyl acetate, potassium oxide, xylene, polyurethane, polyester, and an organosilane

Typically, the glass is first treated with BetasealT 43518 Glass Primer and then Betaseal™ 43520A It is readily apparent that these primers and in particular the Betaseal™ 43518 Glass Primer and Betaseal™ 43520A contain a number of components that improve adhesion of the RIM molded frame to the glass panels Alternatively, one or more primers are used to enhance adhesion as set forth above.

The ballistic glass-clad polycarbonate laminate window 16 is 0.625-1.25 inches thick, preferably 0.75-1.05 inches thick. The laminate window 16 is formed of an outward facing heat strengthened glass sheet 36, at least one alternating polyurethane and polycarbonate interlayers 38, 40 and 38′, a second heat strengthened glass sheet 42, a PBV layer 44 and an inwardly facing spall shield 46. Preferably a second alternating polyurethane and polycarbonate interlayers 40′ and 38″ is provided as shown in the FIG. 4 cross section of the laminate stack.

The door slab 14 is 1.5 to 2.0 inches thick, preferably about 1.75 inches thick. The laminate window 16 is centered within the door slab 14 as illustrated in FIG. 3. The window opening 28 in the door slab is 15-25 inches wide and 48-66 inches tall. The preferred window opening in a 36″ by 80″ door is about 20″ wide by 56″ tall.

The preferred embodiment disclosed is an outwardly opening entryway door assembly capable of withstanding hurricane loads and water surge. The assembly shown in FIGS. 1-3 include the previously described entryway door in combination with a doorjamb 18, hinge set 20 and a peripheral seal 48. The doorjamb 18 defines an opening for an outwardly singing door having a doorjamb abutment 19 which extends about an entire inner periphery of the doorjamb opening. A seal 48 shown in FIG. 5 is compress when the door is closed to trap the seal 48 between the door jamb abutment 19 and the inside face 24 of the door slab 14. Doorjamb 18 can be fabricated using conventional building materials or prefabricated as a one piece unit using metal or fiberglass. Preferably the door jamb 18 is molded as one piece using a reaction injected molded aliphatic polyurethane similar to that used to form the door slab 14.

The outwardly opening entryway door assembly passes the UL Level 1 Ballistic and Forced Entry test and the FEMA ICC-500 Large Missile Impact test. The door assembly can also withstand the 6 foot of water leak test with acceptable minimal amounts water intrusion. The door assembly is suitable for use in FEMA hurricane safety enclosures.

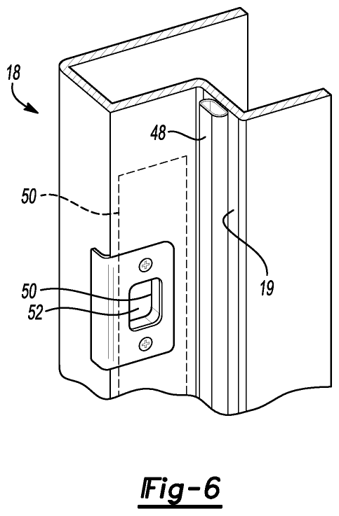

FIG. 6 illustrates a section of the doorjamb 18 on the doorjamb lock side having a striker palate and an insert molded lock bolt reinforcement plate. Ideally the reaction injected molded door frame 18 has a steel reinforcement plate 50 insert molded into the door frame. The reinforcement plate 50 is preferable 6-12 inches long and about 1-1.5 inches wide. The steel reinforcement plate 50 is provided with an aperture 52 sized to receive a strong steel latch bolt 54 of lockset 56. A conventional striker plate 58 is affixed to the door jamb 19 extending about the aperture 52 to engage the latch bolt 54.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An entryway door capable of withstanding hurricane loads and water surge, the door comprising:
a door slab formed of reaction injected molded aliphatic polyurethane having an outward face, and inward face, and a peripheral edge, with a window opening formed therethrough;
a ballistic glass-clad polycarbonate laminate window sized larger than the window opening, the laminate window having a central light transmissive region and an outer boarder region; and
a primer border applied to the outer boarder region of outward and inward faces of the laminate window;
wherein the door slab is reaction injected molded about the laminate window with the outer boarder region extends into and is bonded to a portion of the door slab which extends about the window opening.

2. The entryway door of claim 1, wherein the outer boarder region extends into and is bonded to a portion of the door slab a distance of 1.0-2.5 inches.

3. The entryway door of claim 1, wherein the laminate window is 0.625-1.25 inches thick.

4. The entryway door of claim 3, wherein the laminate window is 0.75-1.05 inches thick.

5. The entryway door of claim 1, wherein the laminate window is formed of an outward facing heat strengthened glass sheet, alternating polyurethane and polycarbonate interlayers a second heat strengthened glass sheet, a PBV layer and an inwardly facing spall shield.

6. The entryway door of claim 1, wherein the door slab is 1.5 to 2.0 inches thick.

7. The entryway door of claim 6, wherein the laminate window is centered within the thickness of the door slab.

8. An outwardly opening entryway door capable of withstanding hurricane loads and water surge, the door comprising:
a door slab formed of reaction injected molded aliphatic polyurethane having an outward face, and inward face, and a peripheral edge, with a window opening formed therethrough, the outer edge of the inward face forming a flat surface for engaging a seal of a doorjamb which extends about the entire periphery of the door slab;
a ballistic glass-clad polycarbonate laminate window sized larger than the window opening, laminate window having a central light transmissive region and an outer boarder region; and
a primer border applied to the outer boarder region of outward and inward faces of the laminate window;
wherein the door slab is reaction injected molded about the laminate window with the outer boarder region extends into and is bonded to a portion of the door slab which extends about the window opening a distance of 1.0-2.5 inches.

9. The outwardly opening entryway door of claim 8, wherein the window opening in the door slab is 15-25 inches wide and 48-66 inches tall.

10. The outwardly opening entryway door of claim 8, wherein the laminate window is 0.75-1.05 inches thick.

11. The outwardly opening entryway door of claim 8, wherein the laminate window is formed of an outward facing heat strengthened glass sheet, alternating polyurethane and polycarbonate interlayers a second heat strengthened glass sheet, a PBV layer and an inwardly facing spall shield.

12. The outwardly opening entryway door of claim 8, wherein the door slab is 1.5 to 2.0 inches thick and the laminate window is centered within the thickness of the door slab.

13. The outwardly opening entryway door of claim 8, wherein the outer boarder region extends into and is bonded to a portion of the door slab a distance of 1.5-2.25 inches.

14. The outwardly opening entryway door of claim 8, wherein the laminated glass passes the UL Level 1 Ballistic and Forced Entry rating.

15. An outwardly opening entryway door assembly capable of withstanding hurricane loads and water surge, the door comprising:
a doorjamb defining an opening for an outwardly singing door. and having a door jamb abutment which extends about an entire inner periphery of the doorjamb opening;
a door comprising:
a door slab formed of reaction injected molded aliphatic polyurethane having an outward face, and inward face, and a peripheral edge, with a window opening formed therethrough, the outer edge of the inward face forming a flat surface for engaging a seal of a doorjamb which extends about the entire periphery of the door slab;
a ballistic glass-clad polycarbonate laminate window sized larger than the window opening, laminate window having a central light transmissive region and an outer boarder region; and
a primer border applied to the outer boarder region of outward and inward faces of the laminate window;
wherein the door slab is reaction injected molded about the laminate window with the outer boarder region extends into and is bonded to a portion of the door slab which extends about the window opening a distance of 1.0-2.5 inches;
a plurality of hinges mounting the door to the doorjamb in and outswing manor; and
a seal positioned between the doorjamb abutment and the periphery of the door to form a watertight seal when the door is closed.

16. The outwardly opening entryway door assembly of claim 15, wherein the laminate window is 0.75-1.05 inches thick.

17. The outwardly opening entryway door assembly of claim 15, wherein the laminate window is formed of an outward facing heat strengthened glass sheet, alternating polyurethane and polycarbonate interlayers a second heat strengthened glass sheet, a PBV layer and an inwardly facing spall shield.

18. The outwardly opening entryway door assembly of claim 15, wherein the door slab is 1.5 to 2.0 inches thick and the laminate window is centered within the thickness of the door slab.

19. The outwardly opening entryway door assembly of claim 15, wherein the outer boarder region extends into and is bonded to a portion of the door slab a distance of 1.5-2.25 inches.

20. The outwardly opening entryway door assembly of claim 15, wherein the window opening in the door slab is 15 to 25 inches wide and 48 to 66 inches tall.
